(19) United States
(12) Patent Application Publication
(10) Pub. No.: US 2022/0377832 A1
(43) Pub. Date: Nov. 24, 2022

(54) METHOD AND APPARATUS FOR CONFIGURING CONNECTED MODE DISCONTINUOUS RECEPTION (CDRX)

(71) Applicant: QUALCOMM Incorporated, San Diego, CA (US)

(72) Inventors: Ling XIE, Beijing (CN); Wei SUN, Beijing (CN); Jie MAO, Beijing (CN); Xuepan GUAN, San Diego, CA (US); Xiaoyu LI, Beijing (CN); Tom CHIN, San Diego, CA (US); Lei SHEN, Beijing (CN); Shan QING, San Diego, CA (US); Zhongyue LOU, Beijing (CN); Qingxin CHEN, San Diego, CA (US); Xiantao LIU, Beijing (CN); Xiaochen CHEN, Beijing (CN)

(21) Appl. No.: 17/753,935

(22) PCT Filed: Sep. 28, 2019
(86) PCT No.: PCT/CN2019/108806

§ 371 Date: Mar. 18, 2022

(51) Int. Cl. H04W 76/28; H04W 76/10

(52) U.S. Cl. CPC H04W 76/28; H04W 76/10

(57) ABSTRACT

Methods, systems, and devices for wireless communications are described. In some systems, a user equipment (UE) may receive a first connected mode discontinuous reception (CDRX) configuration from a first cell associated with a first radio access technology (RAT), the first CDRX configuration includes a first indication of a first on occasion. The UE may receive a second CDRX configuration from a second cell associated with a second RAT, the second CDRX configuration includes a second indication of a second on occasion. The UE may determine that the first on occasion and the second on occasion are separated by a threshold. The UE may transmit, based at least in part on the determination that the first on occasion and the second on occasion are separated by the threshold, a CDRX reconfiguration request message.

### FIELD OF TECHNOLOGY

The present disclosure, for example, relates to wireless communications systems and more particularly to techniques for configuring connected mode discontinuous reception (CDRX).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

Some wireless communications systems may support a UE operating in a dual connectivity (DC) mode. In the DC mode, the UE may concurrently communicate on multiple component carriers (CCs) with multiple cells. For example, the UE may transmit and receive data on CCs from two cell groups (e.g., a master cell group (MCG) and a secondary cell group (SCG)) via a Master node (MN) and a Secondary node (SN). The MN and the SN may operate using the same or different radio access technologies (e.g., LTE, LTE-A, LTE-A Pro, NR, etc.). For example, the MN may be an example of an LTE base station while the SN may be an example of an NR base station or vice versa, among other examples. The UE may communicate with the MN and the SN in the DC mode according to a configuration (e.g., a cell configuration).

### SUMMARY

The present disclosure relates to improved methods, systems, devices, and apparatuses that support techniques for configuring connected mode discontinuous reception (CDRX). For example, the present disclosure provides for configuring connected mode discontinuous reception (CDRX) for a user equipment (UE) operating in a DC mode

In some wireless communications systems, a UE may receive a first connected mode discontinuous reception (CDRX) configuration from a first cell associated with a first radio access technology (RAT), the first CDRX configuration includes a first indication of a first on occasion. The UE may receive a second CDRX configuration from a second cell associated with a second RAT, the second CDRX configuration includes a second indication of a second on occasion. The UE may determine that the first on occasion and the second on occasion are separated by a threshold. The UE may transmit, based at least in part on the determination that the first on occasion and the second on occasion are separated by the threshold, a CDRX reconfiguration request message.

An apparatus for wireless communications at an UE is described. The apparatus may include a memory and a processor coupled to the memory. The processor is configured to receive a first connected mode discontinuous reception (CDRX) configuration from a first cell associated with a first radio access technology (RAT), the first CDRX configuration includes a first indication of a first on occasion. The processor is configured to receive a second CDRX configuration from a second cell associated with a second RAT, the second CDRX configuration includes a second indication of a second on occasion. The processor is configured to determine that the first on occasion and the second on occasion are separated by a threshold. The processor is configured to transmit, based at least in part on the determination that the first on occasion and the second on occasion are separated by the threshold, a CDRX reconfiguration request message.

Another apparatus for wireless communications at an UE is described. The apparatus may include means for receiving a first connected mode discontinuous reception (CDRX) configuration from a first cell associated with a first radio access technology (RAT), the first CDRX configuration includes a first indication of a first on occasion. The apparatus may include means for receiving a second CDRX configuration from a second cell associated with a second RAT, the second CDRX configuration includes a second indication of a second on occasion. The apparatus may include means for determining that the first on occasion and the second on occasion are separated by a threshold. The apparatus may include means for transmitting, based at least in part on the determination that the first on occasion and the second on occasion are separated by the threshold, a CDRX reconfiguration request message.

A non-transitory computer-readable medium storing code for wireless communications at an UE is described. The code may include instructions executable by a processor to receive a first connected mode discontinuous reception (CDRX) configuration from a first cell associated with a first radio access technology (RAT), the first CDRX configuration includes a first indication of a first on occasion. The code may include instructions executable by a processor to receive a second CDRX configuration from a second cell associated with a second RAT, the second CDRX configuration includes a second indication of a second on occasion. The code may include instructions executable by a processor to determine that the first on occasion and the second on occasion are separated by a threshold. The code may include instructions executable by a processor to transmit, based at least in part on the determination that the first on occasion and the second on occasion are separated by the threshold, a CDRX reconfiguration request message.

Some examples of the method, apparatuses, and non-transitory computer-readable medium described herein may further include operations, features, means, or instructions for transmitting, by the UE and/or the base station.

In some examples of the method, apparatuses, and non-transitory computer-readable medium described herein, the UE may establish a first radio resource connection (RRC) connection with the first cell; and establish a second RRC connection with the second cell.

In some examples of the method, apparatuses, and non-transitory computer-readable medium described herein, the first cell includes a master cell group and the second cell includes a secondary cell group.

In some examples of the method, apparatuses, and non-transitory computer-readable medium described herein, the full configuration indicates for the UE to release a set of first dedicated radio configurations and establish a set of second dedicated radio configurations according to the full configuration.

In some examples of the method, apparatuses, and non-transitory computer-readable medium described herein, the UE may determine, based at least in part on the determination that the first on occasion and the second on occasion are separated by the threshold, one or more CDRX reconfiguration parameters.

In some examples of the method, apparatuses, and non-transitory computer-readable medium described herein, the one or more CDRX reconfiguration parameters include at least one of a discontinuous reception (DRX) cycle length, a DRX offset or a DRX active time.

In some examples of the method, apparatuses, and non-transitory computer-readable medium described herein, the CDRX reconfiguration request message includes the one or more CDRX reconfiguration parameters.

In some examples of the method, apparatuses, and non-transitory computer-readable medium described herein, the CDRX reconfiguration request message is an in device coexistence indication message.

In some examples of the method, apparatuses, and non-transitory computer-readable medium described herein, the UE may repeat the determination and the transmission for a number of attempts.

In some examples of the method, apparatuses, and non-transitory computer-readable medium described herein, the UE may stop repeating the determination and the transmission after the number of attempts.

In some examples of the method, apparatuses, and non-transitory computer-readable medium described herein, the first RAT includes one of a new radio (NR), a long-term evolution (LTE), an evolved LTE (eLTE), or a Wi-Fi.

In some examples of the method, apparatuses, and non-transitory computer-readable medium described herein, the second RAT includes one of a new radio (NR), a long-term evolution (LTE), an evolved LTE (eLTE), or a Wi-Fi.

In some examples of the method, apparatuses, and non-transitory computer-readable medium described herein, the UE may establish a third RRC connection with a third cell associated with a third RAT.

### BRIEF DESCRIPTION OF THE DRAWINGS

FIGS. 1 and 2 illustrate examples of wireless communications systems that support techniques for configuring connected mode discontinuous reception (CDRX) configuration in dual connectivity (DC) in accordance with aspects of the present disclosure.

FIG. 3 illustrates examples of process flows that support techniques for configuring connected mode discontinuous reception (CDRX) configuration in DC in accordance with aspects of the present disclosure.

FIG. 4 show techniques for configuring a connected mode discontinuous reception (CDRX) configuration in DC in accordance with aspects of the present disclosure.

FIG. 5 shows a block diagram of a communications manager that supports techniques for configuring a connected mode discontinuous reception (CDRX) configuration in DC in accordance with aspects of the present disclosure.

FIGS. 6 and 7 show block diagrams of devices that support techniques for configuring a connected mode discontinuous reception (CDRX) configuration in DC in accordance with aspects of the present disclosure.

FIG. 8 shows a block diagram of a communications manager that supports techniques for configuring a connected mode discontinuous reception (CDRX) configuration in DC in accordance with aspects of the present disclosure.

FIGS. 9 and 10 show block diagrams of a system including a device that supports techniques for configuring a connected mode discontinuous reception (CDRX) configuration in DC in accordance with aspects of the present disclosure.

FIGS. 11 and 12 show flowcharts illustrating methods that support techniques for configuring a connected mode discontinuous reception (CDRX) configuration in DC in accordance with aspects of the present disclosure.

### DETAILED DESCRIPTION

Some wireless communications systems may include communication devices, such as user equipment (UEs) and base stations, that support multiple radio access technologies. Examples of radio access technologies include fourth generation (4G) technologies, such as Long Term Evolution (LTE), and fifth generation (5G) technologies, such as New Radio (NR). A UE, in some examples, may communicate using one or more radio access technologies in accordance with operating in a dual connectivity (DC) mode. The DC mode may allow the communication device to concurrently communicate (e.g., transmit and receive information in the form of packets) on multiple component carriers (CCs) from at least two cell groups. For example, a UE may communicate with a master base station or master node (MN) (e.g., a master eNB (MeNB), a master gNB (MgNB), etc.) in a master cell group (MCG) and a secondary base station or secondary node (SN) (e.g., a secondary eNB (SeNB), a secondary gNB (SgNB), etc.) in a secondary cell group (SCG). The CCs may be configured into a primary cell associated with the MCG and a secondary cell associated with the SCG. In some examples, the master base station may correspond to the primary cell, while the secondary base station may correspond to the secondary cell.

The primary cell may, in some examples, correspond to one radio access technology while the secondary cell may correspond to another radio access technology. For example, the primary cell may correspond to LTE, while the secondary cell may correspond to NR. Alternatively, the primary cell may correspond to NR, while the secondary cell may correspond to LTE, or the primary and secondary cells may correspond to a same radio access technology. The communication devices may communicate with one or more of the primary cells or the secondary cell on one or more of the configured CCs.

In some cases, an MN may configure a UE operating in a DC mode with a first connected mode discontinuous reception (CDRX) cycle. An SN may configure the UE operating in a DC mode with a second connected mode discontinuous reception (CDRX) cycle. In some cases, the MN and the SN may not coordinate the between each other when configuring, the UE operating in a DC mode with, the first connected mode discontinuous reception (CDRX) cycle and the second connected mode discontinuous reception (CDRX) cycle. The lack of coordination between the MN and the SN when configuring the first connected mode discontinuous reception (CDRX) cycle and the second connected mode discontinuous reception (CDRX) cycle may result in separate and non-overlapping ON occasions where the UE wakes to monitoring transmission from the MN and the SN. In some cases, the separate and non-overlapping ON occasions may require UE to wake up (e.g., power up) during separate occasions and thus may require additional power.

In contrast, some systems may implement techniques for configuring connected mode discontinuous reception (CDRX). For example, an MN may configure a UE operating in a DC mode with a first connected mode discontinuous reception (CDRX) cycle. An SN may configure the UE operating in a DC mode with a second connected mode discontinuous reception (CDRX) cycle. The UE operating in DC mode may determine whether the first ON occasion indicated by the first connected mode discontinuous reception (CDRX) cycle and the second ON occasion indicated by the second connected mode discontinuous reception (CDRX) cycle are separated by a time threshold. For example, the first connected mode discontinuous reception (CDRX) cycle may include a first indication of a first ON occasion. In another example, the second connected mode discontinuous reception (CDRX) cycle may include a second indication of a second ON occasion. The UE operating in a DC mode may determine whether the first ON occasion and the second ON occasion are separated by a time threshold. When the UE determines that the first ON occasion and the second ON occasion are separated by (or exceed) the time threshold, the UE may determine one or more CDRX reconfiguration parameters. For example, the one or more CDRX reconfiguration parameters may include a discontinuous reception (DRX) cycle length, a DRX offset, and/or a DRX active time. The UE may determine the one or more CDRX reconfiguration parameters in order to align (or minimize the separation of) the first ON occasion and the second ON occasion. By aligning (or minimize the separation of) the first ON occasion and the second ON occasion, the UE may require to only wake up (or power up) once and thus reduce power consumption.

In some cases, UE operating in DC mode may transmit a CDRX reconfiguration request message to the MN and/or the SN. For example, the UE may transmit a CDRX reconfiguration request message based on the determination that the first ON occasion and the second ON occasion are separated by (or exceed) the time threshold. The UE operating in DC mode may request from the MN and/or the SN a new CDRX configuration in order to align (or minimize the separation of) the first ON occasion and the second ON occasion. In some aspects, the CDRX reconfiguration request message may include one or more CDRX reconfiguration parameters. In other aspects, the CDRX reconfiguration request message may be an in-device coexistence indication message.

In some aspects, the UE may or may not receive a new connected mode discontinuous reception (CDRX) configuration from the MN and/or the SN. When the UE receives a new connected mode discontinuous reception (CDRX) configuration from the MN and/or the SN, the UE may repeat the determination of whether the ON occasion configured by the MN and the ON occasion configured by the SN are separated by a time threshold. As described above, when the UE determines that the first ON occasion configured by the MN and the second ON occasion configured by the SN are separated by (or exceed) the time threshold, the UE may again determine one or more CDRX reconfiguration parameters. Thereafter, the UE may transmit the CDRX reconfiguration request message again to the MN and/or the SN including the one or more CDRX reconfiguration parameters. In some aspects, the UE may repeat the determination of whether the first ON occasion and the second ON occasion are separated by a time threshold and transmission of the CDRX reconfiguration request message a number of times. In another aspects, the UE may repeat the determination of whether the first ON occasion and the second ON occasion are separated by a time threshold and transmission of the CDRX reconfiguration request message until the first ON occasion configured by the MN and the second ON occasion configured by the SN are separated by less than a time threshold.

Aspects of the disclosure are initially described in the context of wireless communications systems. Additional aspects are described with respect to process flows. Aspects of the disclosure are further illustrated by and described with reference to apparatus diagrams, system diagrams, and flowcharts that relate to techniques for indicating full configuration to an SN in DC.

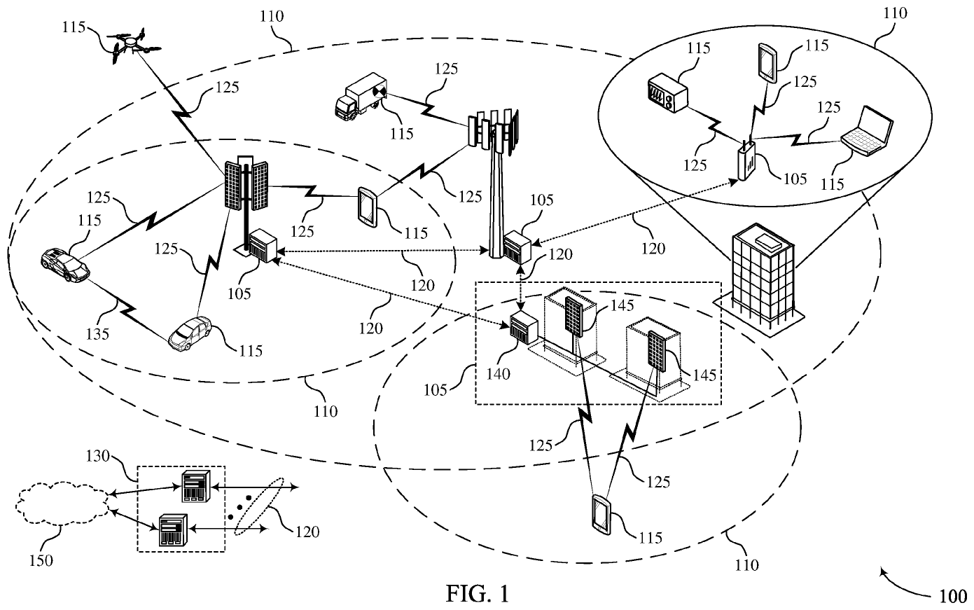

FIG. 1 illustrates an example of a wireless communications system 100 that supports techniques configuring connected mode discontinuous reception (CDRX) in accordance with aspects of the present disclosure. The wireless communications system 100 may include base stations 105, UEs 115, and a core network 130. In some examples, the wireless communications system 100 may be an LTE network, an LTE-Advanced (LTE-A) network, an LTE-A Pro network, or an NR network. In some cases, the wireless communications system 100 may support enhanced broadband communications, ultra-reliable (e.g., mission critical) communications, low latency communications, communications with low-cost and low-complexity devices, or any combination thereof.

Base stations 105 may be dispersed throughout a geographic area to form the wireless communications system 100 and may be devices in different forms or having different capabilities. Base stations 105 and UEs 115 may wirelessly communicate via one or more communication links 125. Each base station 105 may provide a coverage area 110 over which UEs 115 and the base station 105 may establish communication links 125. The coverage area 110 may be an example of a geographic area over which a base station 105 and a UE 115 support the communication of signals according to one or more radio access technologies.

UEs 115 may be dispersed throughout a coverage area 110 of the wireless communications system 100, and each UE 115 may be stationary, or mobile, or both at different times. UEs 115 may be devices in different forms or having different capabilities. Some example UEs 115 are illustrated in FIG. 1. The UEs 115 described herein may be able to communicate with various types of devices, such as other UEs 115, base stations 105, and/or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with the core network 130 through backhaul links 120 (e.g., via an S1, N2, N3, or other interface). Base stations 105 may communicate with one another over backhaul links 120 (e.g., via an X2, Xn, or other interface) either directly (e.g., directly between base stations 105), or indirectly (e.g., via core network 130), or both. In some examples, backhaul links 120 may be or include one or more wireless links.

One or more of base stations 105 described herein may include or may be referred to by a person of ordinary skill in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, a machine type communications (MTC) device, or the like, which may be implemented in various objects such as appliances, vehicles, meters, or the like.

The UEs 115 described herein may be able to communicate with various types of devices, such as other UEs 115 that may sometimes act as relays as well as base stations 105 and network equipment including macro eNBs or gNBs, small cell eNBs or gNBs, relay base stations, and the like, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting communication links 125. For example, a carrier used for a communication link 125 may include a portion of a radio frequency spectrum band (e.g., a bandwidth part (BWP)) that is operated according to physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

Time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some cases, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some cases, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or various combinations thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, exterior spaces between or overlapping with geographic coverage areas 110, or the like.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, overlapping geographic coverage areas 110 associated with different technologies may be supported by different base stations 105. The wireless communications system 100 may include, for example, a heterogeneous network in which different types of base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some cases, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some cases, groups of UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), a user plane function (UPF)). The control plane entity may manage non-access stratum (NAS) functions such as mobility, authentication, and bearer management for UEs 115 served by base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with UEs 115 through a number of other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example, in the range of 300 megahertz (MHz) to 300 gigahertz (GHz). For example, the region from 300 MHz to 3 GHz is known as the ultra-high frequency (UHF) region or decimeter band, since the wavelengths range from approximately one decimeter to one meter in length. UHF waves may be blocked or redirected by buildings and environmental features, but the waves may penetrate structures sufficiently for a macro cell to provide service to UEs 115 located indoors. Transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between UEs 115 and base stations 105, and EHF antennas of the respective devices may be smaller and more closely spaced than UHF antennas. In some cases, this may facilitate use of antenna arrays within a device. The propagation of EHF transmissions, however, may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some cases, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, D2D transmissions, or the like.

A base station 105 or UE 115 may be equipped with multiple antennas, which may be used to employ techniques such as transmit diversity, receive diversity, multiple-input multiple-output (MIMO) communications, or beamforming. The antennas of a base station 105 or UE 115 may be located within one or more antenna arrays or antenna panels, which may support MIMO operations or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at specific orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a specific orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The media access control (MAC) layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or core network 130 supporting radio bearers for user plane data. At the Physical layer, transport channels may be mapped to physical channels.

In a DC mode, a UE 115 may contemporaneously communicate (e.g., maintain connections with) multiple CCs from multiple cells via multiple base stations 105, where a first base station 105 may act as an MN and a second base station 105 may act as an SN. A base station 105 operating as an MN may transmit, a first connected mode discontinuous reception (CDRX) configuration to the UE 115. A base station 105 operating as an SN, may transmit a second connected mode discontinuous reception (CDRX) configuration to the UE 115. For example, the first connected mode discontinuous reception (CDRX) configuration may include a first indication of a first ON occasion of a first connected mode discontinuous reception (CDRX) cycle and the second connected mode discontinuous reception (CDRX) configuration may include a second indication of a second ON occasion of a second connected mode discontinuous reception (CDRX) cycle.

In some aspects, the base station 105 operating as the MN and the base station 105 operating as the SN, may not communication with each other when configuring the first connected mode discontinuous reception (CDRX) configuration and the second connected mode discontinuous reception (CDRX) configuration, respectively. Therefore, the first connected mode discontinuous reception (CDRX) configuration may indicate a first ON occasion that may be separated from (e.g., not aligned with) a second ON occasion indicated by the second connected mode discontinuous reception (CDRX) configuration. The UE 115 may receive the first connected mode discontinuous reception (CDRX) configuration and the second connected mode discontinuous reception (CDRX) configuration from the base station 105 operating as MN and the base station 105 operating as SN.

In some cases, the UE 115 may determine whether the first ON occasion indicated by the first connected mode discontinuous reception (CDRX) configuration is separated from the second ON occasion indicated by the second connected mode discontinuous reception (CDRX) configuration by more than a time threshold. When the UE 115 determines that the first ON occasion indicated by the first connected mode discontinuous reception (CDRX) configuration is separated from the second ON occasion indicated by the second connected mode discontinuous reception (CDRX) configuration by more than a time threshold, the UE 115 may determine one or more CDRX reconfiguration parameter to better align the first ON occasion and the second ON occasion. The UE 115 may transmit a CDRX reconfiguration request message to the base station 115 operating as the MN and/or the base station 105 operating as the SN. For example, the CDRX reconfiguration request message may be an in-device coexistence message. In other examples, the CDRX reconfiguration request message may include one or more CDRX reconfiguration parameters.

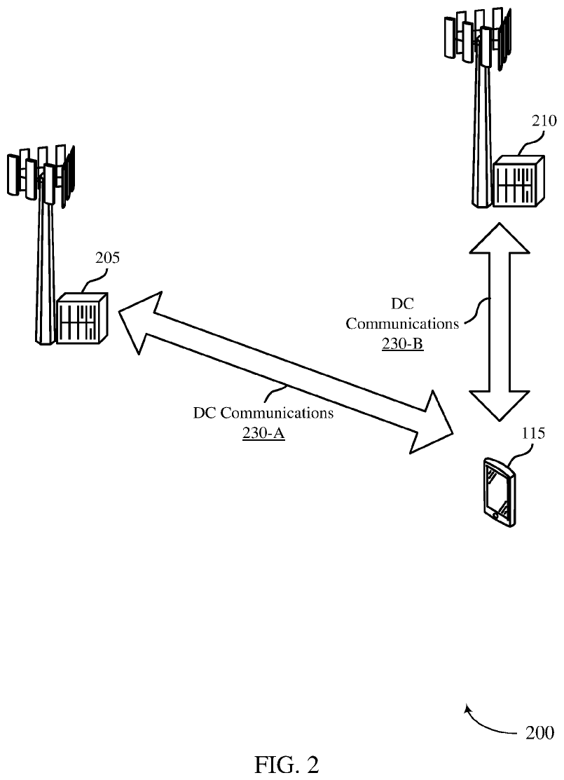

FIG. 2 illustrates an example of a wireless communications system 200 that supports techniques for configuring connected mode discontinuous reception (CDRX) in accordance with aspects of the present disclosure. In some examples, the wireless communications system 200 may implement aspects of a wireless communications system 100. For example, the wireless communications system 200 may include a UE 115 and base stations 105, which may be examples of the corresponding devices described with reference to FIG. 1. One base station in the wireless communications system 200 may operate as an MN 205, while another base station may operate as an SN 210. The MN 205 and the SN 210 may support DC communications with the UE 115. In other aspects, even though FIG. 2 illustrates the MN 205 and the SN 210, one or more additional base stations (e.g., as illustrated in FIG. 1) may support DC communications with the UE 115. The MN 205 and SN 210 may support configuration and/or reconfiguration of the UE 115 with a connected mode discontinuous reception (CDRX) configuration by the MN 205 and/or the SN 210.

The UE 115 may operate in a DC mode with a base station operating as an MN 205 and a base station operating as an SN 210. The MN 205 may provide network coverage for a cell in an MCG and the SN 210 may provide coverage for a cell in an SCG. Initially, the UE 115 may perform DC communications 230-a with the MN 205 according to a first MCG configuration and may perform DC communications 230-b with the SN 210 according to a first SCG configuration. In an example, the UE 115 may establish a first radio resource control (RRC) connection 230-a with the MN 205 according to the first MCG configuration. In another example, the UE 115 may establish a second radio resource control (RRC) connection 230-b according to the first SCG configuration.

The wireless communications system 200 may support multiple DC mode types in which a UE 115, an MN 205, and an SN 210 may communicate. For example, the UE 115 may communicate with both the MN 205 and the SN 210 according to an E-UTRA configuration. In other examples, the UE 115 may communicate with both the MN 205 and the SN 210 according to an NR configuration. This type of DC mode may be known as NR-DC. In some examples, the UE 115 may communicate with the MN 205 according to an NR configuration and with the SN 210 according to an E-UTRA configuration in what may be referred to as NE-DC. Alternatively, in some other examples, the UE 115 may communicate with the MN 205 according to an E-UTRA configuration and with the SN 210 according to an NR configuration in what may be referred to as EN-DC. In yet other examples, the UE 115 may communicate with the MN 205 according to a next generation core (NGC) E-UTRA configuration and with the SN 210 according to an NR configuration in what may be known as NGEN-DC mode. In other examples, the UE 115 may communicate with a wireless local area network (e.g., Wi-Fi) (not shown) in addition to communicating with the MN 205 and the SN 210 according to the DC mode types as discussed above. The UE 115 may support any other DC mode types for communicating with the MN 205 and the SN 210.

In some aspect, the UE 115 may establish a first radio resource control (RRC) connection 230-A with the MN 205 when the UE 115 is operating in a DC mode. The UE 115 may establish a second radio resource control (RRC) connection 230-B with the SN 210 when the UE is operating in a DC mode. The MN 205 may configure a first connected mode discontinuous reception (CDRX) configuration, for the UE 115, having a first indication of a first ON occasion. The SN 210 may configure a second connected mode discontinuous reception (CDRX) configuration, for the UE 115, having a second indication of a second ON occasion. The MN 205 may transmit the first connected mode discontinuous reception (CDRX) configuration having a first indication of a first ON occasion to the UE 115 via the first RRC connection 230-A. The SN 210 may transmit the second connected mode discontinuous reception (CDRX) configuration having a second indication of a second ON occasion to the UE 115 via the second RRC connection 230-B.

In some aspects, the UE 115 may receive the first connected mode discontinuous reception (CDRX) configuration having a first indication of a first ON occasion via the first RRC connection 230-A. In other aspects, the UE 115 may receive the second connected mode discontinuous reception (CDRX) configuration having a second indication of a second ON occasion via the second RRC connection 230-B. The UE 115 may determine whether the first ON occasion of the first connected mode discontinuous reception (CDRX) configuration is separated from the second ON occasion of the second connected mode discontinuous reception (CDRX) configuration by more than a time threshold. When the UE 115 determines that the first ON occasion of the first connected mode discontinuous reception (CDRX) configuration is separated (e.g., not aligned) from the second ON occasion of the second connected mode discontinuous reception (CDRX) configuration by more than a time threshold, the UE 115 may determine one or more CDRX reconfiguration parameter. For example, the one or more CDRX reconfiguration parameters may allow the first ON occasion of the first connected mode discontinuous reception (CDRX) configuration to be separated from the second ON occasion of the second connected mode discontinuous reception (CDRX) configuration by less than the time threshold. In other examples, the UE 115 may determine the one or more CDRX reconfiguration parameters for the MN 205 and/or the SN 210. In various aspects, the one or more CDRX reconfiguration parameters may include a discontinuous reception (DRX) cycle length, a DRX offset and/or a DRX active time.

In some aspects, the UE 115 may transmit a CDRX reconfiguration request message to the MN 205 and/or the SN 210. In an example, the CDRX reconfiguration request message may be an in-device coexistence indication message. The CDRC reconfiguration request message may include the one or more CDRX reconfiguration parameters determined by the UE 115. In an example, the UE 115 may transmit the CDRX reconfiguration request message to the MN 201 via the first RRC connection 203-A. In another example, the UE 115 may receive the CDRX reconfiguration request message to the SN 210 via the second RRC connection 203-B. In some examples, the UE 115 may transmit a first CDRX reconfiguration request message including first CDRX reconfiguration parameters to the MN 205. Alternatively or in addition to, the UE 115 may transmit a second CDRX reconfiguration request message including second CDRX reconfiguration parameters to the SN 210. In some aspects, the first CDRX reconfiguration request message transmitted to the MN 205 may be different from the second CDRX reconfiguration request message transmitted to the SN 210. In other aspects, the first CDRX reconfiguration request message transmitted to the MN 205 may be the same as the second CDRX reconfiguration request message transmitted to the SN 210.

In some aspect, the MN 205 may receive the CDRX reconfiguration request message, transmitted by the UE 115, via the first RRC connection 230-A. In other aspects, the SN 210 may receive the CDRX reconfiguration request message, transmitted by the UE, via the second RRC connection 230-B. The MN 205 and/or the SN 210 may identify one or more CDRX reconfiguration parameters included in the CDRX reconfiguration request message. In some aspects, the MN 205 may reconfigure the first connected mode discontinuous reception (CDRX) configuration based at least in part on the identified one or more CDRX reconfiguration parameters. In other aspects, the SN 210 may reconfigure the second connected mode discontinuous reception (CDRX) configuration based at least in on the identified one or more CDRX reconfiguration parameters. The MN 205 may transmit the first reconfigured discontinuous reception (CDRX) configuration having a first indication of a first reconfigured ON occasion to the UE 115 via the first RRC connection 230-A. The SN 210 may transmit the second reconfigured discontinuous reception (CDRX) configuration having a second indication of a second reconfigured ON occasion to the UE 115 via the second RRC connection 230-B.

The UE 115 may receive the first reconfigured discontinuous reception (CDRX) configuration to the UE 115 via the first RRC connection 230-A and the second reconfigured discontinuous reception (CDRX) configuration to the UE 115 via the second RRC connection 230-B. The UE 115 may repeat the determination of whether the first reconfigured ON occasion of the first reconfigured connected mode discontinuous reception (CDRX) configuration is separated from the second reconfigured ON occasion of the second connected mode discontinuous reception (CDRX) configuration by more than a time threshold, as described above. When the UE 115 determines that the first reconfigured ON occasion of the first reconfigured connected mode discontinuous reception (CDRX) configuration is separated (e.g., not aligned) from the second reconfigured ON occasion of the second connected mode discontinuous reception (CDRX) configuration by more than a time threshold, the UE 115 may repeat the determination of one or more CDRX reconfiguration parameter, as discussed above. Alternatively, or in addition to, the UE 115 may repeat the transmission of the CDRX reconfiguration request message to the MN 205 and/or the SN 210. In some aspects, the UE 115 may repeat the above described steps, until the first ON occasion of the first connected mode discontinuous reception (CDRX) configuration is separated from the second ON occasion of the second connected mode discontinuous reception (CDRX) configuration by less than a time threshold. In other aspects, the UE 115 may repeat the above descried steps, a number of attempts.

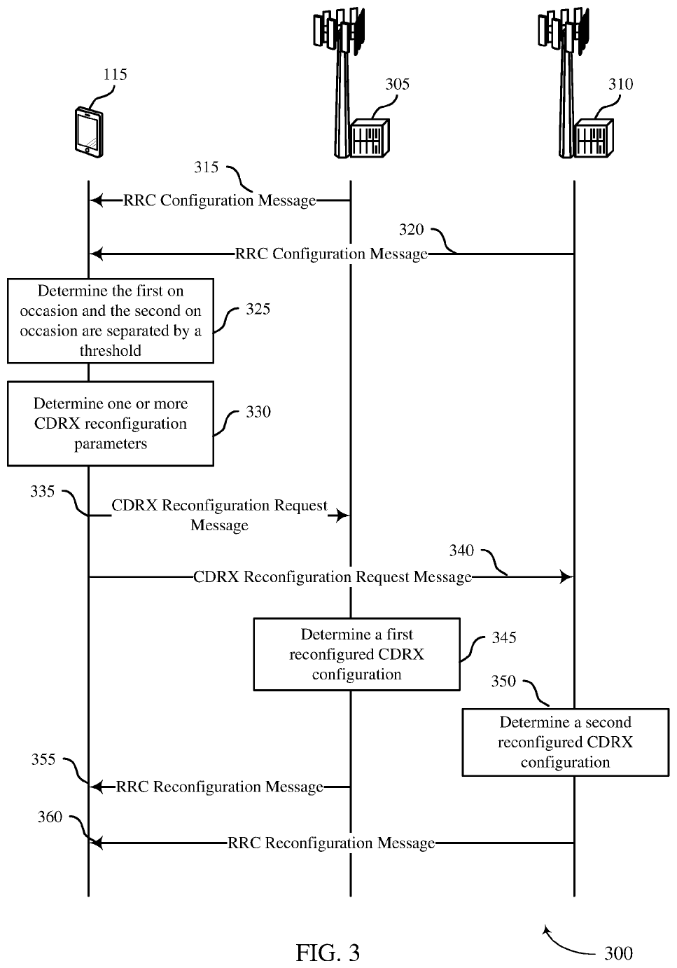

FIG. 3 illustrates an example of a process flow 300 that supports techniques for configuring discontinuous reception (CDRX) configuration in DC in accordance with aspects of the present disclosure. In some examples, the process flow 300 may implement aspects of a wireless communications system 100 or a wireless communications system 200 as described with references to FIGS. 1 and 2. The process flow 300 may include a UE 115 and base stations 105, which may be examples of a UE 115 and base stations 105 as described with reference to FIGS. 1 and 2. A first base station may be an example of an MN 305 in DC operations and a second base station may be an example of an SN 310 in DC operations. In the following description of the process flow 300, the operations performed by the UE 115, the MN 305, and the SN 310 may be performed in different orders or at different times. Some operations may also be left out of the process flow 300, or other operation may be added to the process flow 300. While the UE 115, the MN 305, and the SN 310 are shown performing a number of the operations of process flow 300, any wireless device may perform the operations shown or described. The process flow 300 may illustrate the signaling of reconfiguration information in DC communications.

At 315, the MN 305 may establish a first radio resource control (RRC) connection with the UE 115 operating in the DC mode via a first RRC configuration message. A first RRC connection may include the configuration of several layers including the lower-layer configurations for different cells—and any updates thereto)—to allow the UE 115 to establish communication with multiple nodes of the DC deployment. For example, the configuration may involve a physical layer reconfiguration, a MAC layer reconfiguration, or a combination thereof.

The MN 305 may transmit an RRC configuration message to the UE 115 to establish the first RRC connection with the UE 115. The RRC configuration message may include a first discontinuous reception (CDRX) configuration having a first indication of a first ON occasion. The UE 115 may receive the first discontinuous reception (CDRX) configuration having the first indication of a first ON occasion via the RRC connection with the MN 305.

At 320, the SN 310 may establish a radio resource control (RRC) connection with the UE 115 operating in the DC mode via a second RRC configuration message. A second RRC connection may include the configuration of several layers including the lower-layer configurations for different cells—and any updates thereto)—to allow the UE 115 to establish communication with multiple nodes of the DC deployment. For example, the configuration may involve a physical layer reconfiguration, a MAC layer reconfiguration, or a combination thereof.

The SN 310 may transmit an RRC configuration message to the UE 115 to establish the second RRC connection with the UE 115. The RRC configuration message from the SN 310 may include a second discontinuous reception (CDRX) configuration having a second indication of a second ON occasion. The UE 115 may receive the second discontinuous reception (CDRX) configuration having the second indication of a second ON occasion via the RRC connection with the SN 310.

At 325, the UE 115 may determine whether the first ON occasion of the first connected mode discontinuous reception (CDRX) configuration is separated from the second ON occasion of the second connected mode discontinuous reception (CDRX) configuration by more than a time threshold. When the UE 115 determines that the first ON occasion of the first connected mode discontinuous reception (CDRX) configuration is separated from the second ON occasion of the second connected mode discontinuous reception (CDRX) configuration by less than a time threshold, the UE 115 may be configured with the first discontinuous reception (CDRX) configuration and the second discontinuous reception (CDRX) configuration.

At 330, the UE 115 may determine one or more CDRX reconfiguration parameters based at least in part on the determination that the first ON occasion of the first connected mode discontinuous reception (CDRX) configuration is separated from the second ON occasion of the second connected mode discontinuous reception (CDRX) configuration by more than a time threshold. For example, the one or more CDRX reconfiguration parameters may include a discontinuous reception (DRX) cycle length, a DRX offset and/or a DRX active time. In some aspects, the UE 115 may determine one or more CDRX reconfiguration parameters for the MN 305. Alternatively, or in addition to, the UE 115 may determine one or more CDRX reconfiguration parameters for the SN 310.

At 335, the UE 115 may transmit an CDRX reconfiguration request message to the MN 305. The UE 115 may transmit the CDRX reconfiguration request message to indicate to the MN 305 that a new discontinuous reception (CDRX) configuration is desired. The CDRX reconfiguration request message may be an in-device coexistence indication message. The CDRX reconfiguration request message may include the one or more CDRX reconfiguration parameters determined by the UE 115.

At 340, the UE 115 may optionally transmit an CDRX reconfiguration request message to the SN 310. The UE 115 may transmit the CDRX reconfiguration request message to indicate to the SN 305 that a new discontinuous reception (CDRX) configuration is desired. The CDRX reconfiguration request message may be an in-device coexistence indication message. The CDRX reconfiguration request message may include the one or more CDRX reconfiguration parameters determined by the UE 115. In an example, the CDRX reconfiguration request message transmitted to the SN 310 may be the same as the CDRX reconfiguration request message transmitted to the MN 305 at 335. In another example, the CDRX reconfiguration request message transmitted to the SN 310 may be different from the CDRX reconfiguration request message transmitted to MN 305 at 335. For example, the CDRX reconfiguration request message transmitted to the SN 310 may include one or more CDRX reconfiguration parameters for the SN 310, while the CDRX reconfiguration request message transmitted to the Mn 305 may include one or more CDRX reconfiguration parameters for the MN 305.

At 345, the MN 305 may determine a first reconfigured discontinuous reception (CDRX) configuration based at least in part on the received CDRX reconfiguration request message. For example, the MN 305 may identify one or more CDRX reconfiguration parameters included in the received CDRX reconfiguration request message. The MN 305 may configure a first reconfigured discontinuous reception (CDRX) configuration based at least in part on the identified one or more CDRX reconfiguration parameters.

At 350, the SN 310 may optionally determine a second reconfigured discontinuous reception (CDRX) configuration based at least in part on the received CDRX reconfiguration request message. For example, the MN 305 may identify one or more CDRX reconfiguration parameters included in the received CDRX reconfiguration request message. The SN 305 may configure a second reconfigured discontinuous reception (CDRX) configuration based at least in part on the identified one or more CDRX reconfiguration parameters.

At 355, the MN 305 may transmit the first reconfigured discontinuous reception (CDRX) configuration to the UE 115 via a first RRC reconfiguration message. The first reconfigured discontinuous reception (CDRX) configuration may be included in a radio resource control (RRC) message. The first reconfigured discontinuous reception (DRX) configuration may include a first indication of a first reconfigured ON occasion.

At 360, the SN 310 may transmit the second reconfigured discontinuous reception (CDRX) configuration to the UE 115 via a second RRC reconfiguration message. The second reconfigured discontinuous reception (CDRX) configuration may be included in a radio resource control (RRC) message. The second reconfigured discontinuous reception (DRX) configuration may include a second indication of a second reconfigured ON occasion.

In some aspects, the UE 115 may receive the first reconfigured discontinuous reception (CDRX) configuration from the MN 305 and/or the second reconfigured discontinuous reception (CDRX) configuration from the SN 310. The UE 115 may repeat the steps of 325-340 (as described above) based at least in part on the received first reconfigured discontinuous reception (CDRX) configuration and/or the second reconfigured discontinuous reception (CDRX) configuration. In some aspects, the UE 115 may repeat the steps of 325-340 until the first ON occasion of the first connected mode discontinuous reception (CDRX) configuration is separated from the second ON occasion of the second connected mode discontinuous reception (CDRX) configuration by less than a time threshold. In other aspects, the UE may repeat the steps of 325-340 for a number of time (e.g., 3-4 times).

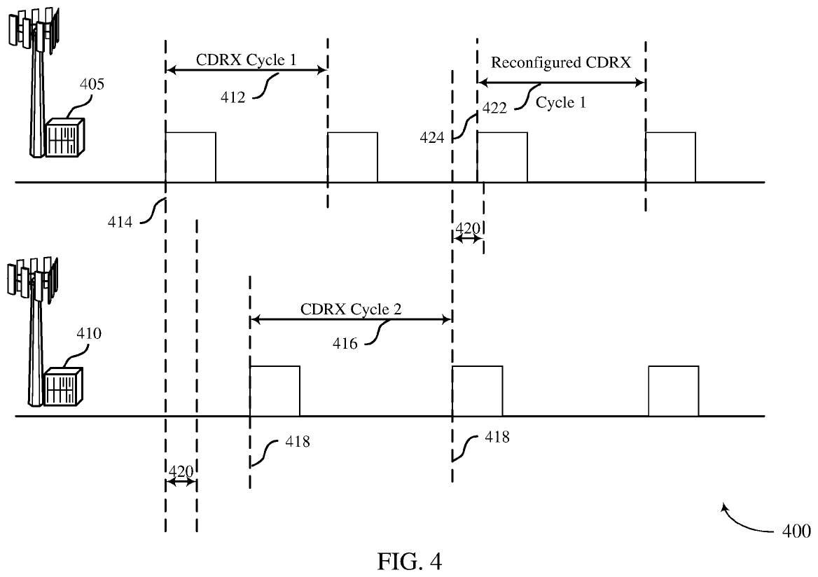

FIG. 4 illustrates an example of a process flow 400 that supports techniques for configuring discontinuous reception (CDRX) configuration in DC in accordance with aspects of the present disclosure. In some examples, the process flow 400 may implement aspects of a wireless communications systems 100 or a wireless communications system 200 as described with reference to FIGS. 1 and 2. The process flow 400 includes base stations 105, which may be examples of the corresponding wireless devices described with reference to FIGS. 1 and 2. A first base station may be an example of an MN 405 in DC operations and a second base station may be an example of an SN 410 in DC operations. In the following description of the process flow 400, the operations performed by the UE 115, the MN 405, and the SN 410 may be performed in different orders or at different times. Some operations may also be left out of the process flow 400, or other operations may be added to the process flow 400. While the UE 115, the MN 405, and the SN 410 are shown performing a number of the operations of the process flow 400, any wireless device may perform the operations shown or described. The process flow 400 may further illustrate the signaling of reconfiguration information in DC communications.

The MN 405 may configure a first discontinuous reception (CDRX) configuration for the UE 115. For example, the first discontinuous reception (CDRX) configuration may include a first CDRX cycle 412 having a first DRX cycle length, a first DRX offset, and/or a first DRX ON occasion (active time). As shown in FIG. 4, the first CDRX cycle 412 may include a first indication 414 of first DRX ON occasion (active time). The SN 410 may configure a second discontinuous reception (CDRX) configuration for the UE 115. For example, the second discontinuous reception (CDRX) configuration may include a second CDRX cycle 416 having a second DRX cycle length, a second DRX offset, and/or a second DRX ON occasion (active time). As shown in FIG. 4, the second CDRX cycle 416 may include a second indication 418 of second DRX ON occasion (active time).

As described above, the UE 115 may determine whether the first ON occasion 414 of the first connected mode discontinuous reception (CDRX) configuration is separated from the second ON occasion 418 of the second connected mode discontinuous reception (CDRX) configuration by more than a time threshold 420. As shown in FIG. 4, the first ON occasion 414 of the first connected mode discontinuous reception (CDRX) configuration is separated from the second ON occasion 418 of the second connected mode discontinuous reception (CDRX) configuration by more than a time threshold 420. The UE 115 may transmit a CDRX reconfiguration request message to the MN 405 based at least in part on the first ON occasion 414 of the first connected mode discontinuous reception (CDRX) configuration is separated from the second ON occasion 418 of the second connected mode discontinuous reception (CDRX) configuration by more than a time threshold 420.

In some aspects, the MN 410 may reconfigure a first reconfigured discontinuous reception (CDRX) configuration. For example, the first reconfigured discontinuous reception (CDRX) configuration may include a first reconfigured CDRX cycle 422 having a first reconfigured DRX cycle length, a first reconfigured DRX offset, and/or a first reconfigured DRX ON occasion (active time). As shown in FIG. 4, the first reconfigured CDRX cycle 422 may include a first indication of first reconfigured DRX ON occasion (active time) 424. Again, the UE 115 may determine whether the first ON occasion 414 of the first connected mode discontinuous reception (CDRX) configuration is separated from the second ON occasion 418 of the second connected mode discontinuous reception (CDRX) configuration by more than a time threshold 420. As shown in FIG. 4, the first reconfigured ON occasion 424 of the first reconfigured connected mode discontinuous reception (CDRX) configuration is separated from the second ON occasion 418 of the second connected mode discontinuous reception (CDRX) configuration by less than the time threshold 420.

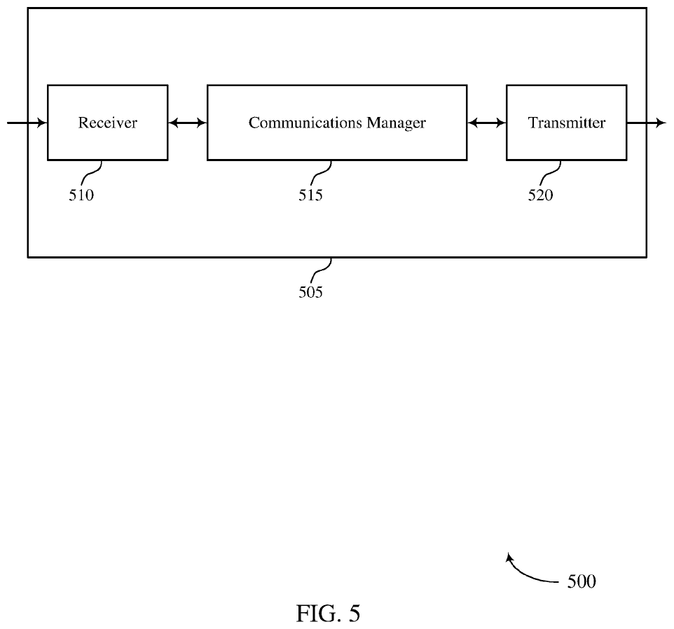

FIG. 5 shows a block diagram 500 of a device 505 that supports techniques for configuring connected mode discontinuous reception (CDRX) in DC in accordance with aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

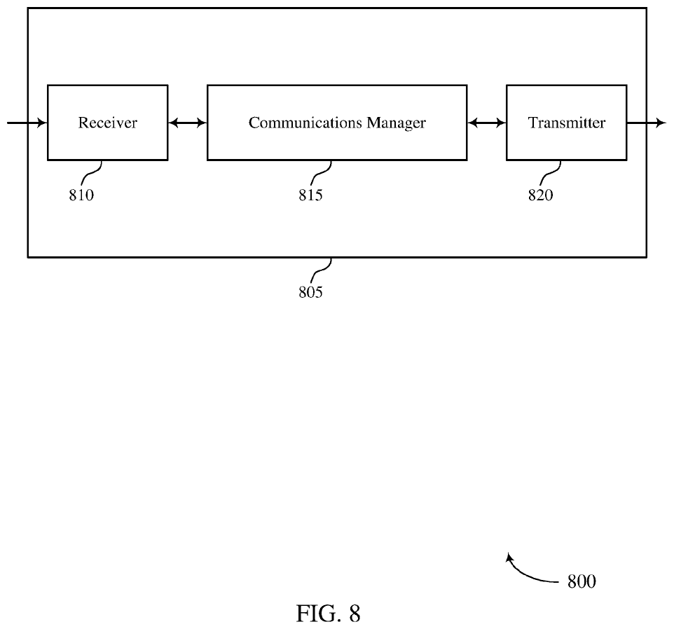

The receiver 510 may receive information such as packets, user data, or control information associated with various information channels (e.g., control channels, data channels, and information related to techniques for configuring connected mode discontinuous reception (CDRX) in DC, etc.). Information may be passed on to other components of the device 505. The receiver 510 may be an example of aspects of the transceiver 720 described with reference to FIG. 8. The receiver 510 may utilize a single antenna or a set of antennas.

The communications manager 515 may communicate with an MN and an SN in a DC mode, receive, from the MN associated with a first radio access technology (RAT), a first connected mode discontinuous reception (CDRX) configuration, the first CDRX configuration includes a first indication of a first ON occasion. The communications manager 515 may, receive, from the SN associated with a second radio access technology (RAT), a second CDRX configuration, the second CDRX configuration include a second indication of a second ON occasion. The communication manager 515 may determine that the first on occasion and the second on occasion are separated by a threshold, determine, based at least in part on the determination that the first on occasion and the second on occasion are separated by the threshold, one or more CDRX reconfiguration parameters, and transmit, based at least in part on the determination that the first on occasion and the second on occasion are separated by the threshold, a CDRX reconfiguration request message. The communications manager 515 may be an example of aspects of the communications manager 710 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

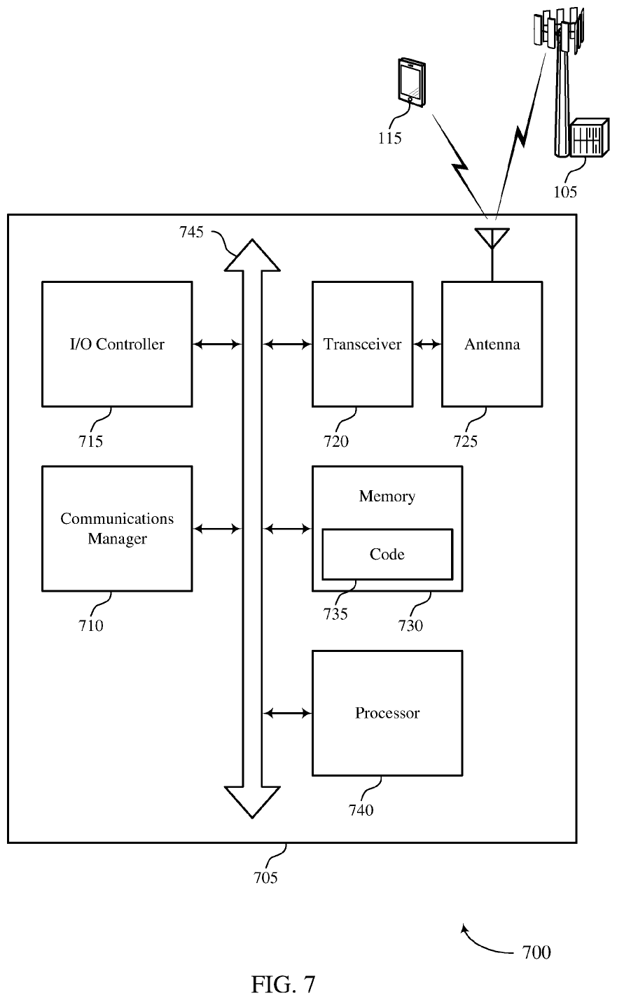

The transmitter 520 may transmit signals generated by other components of the device 505. In some examples, the transmitter 520 may be collocated with a receiver 510 in a transceiver component. For example, the transmitter 520 may be an example of aspects of the transceiver 720 described with reference to FIG. 7. The transmitter 520 may utilize a single antenna or a set of antennas.

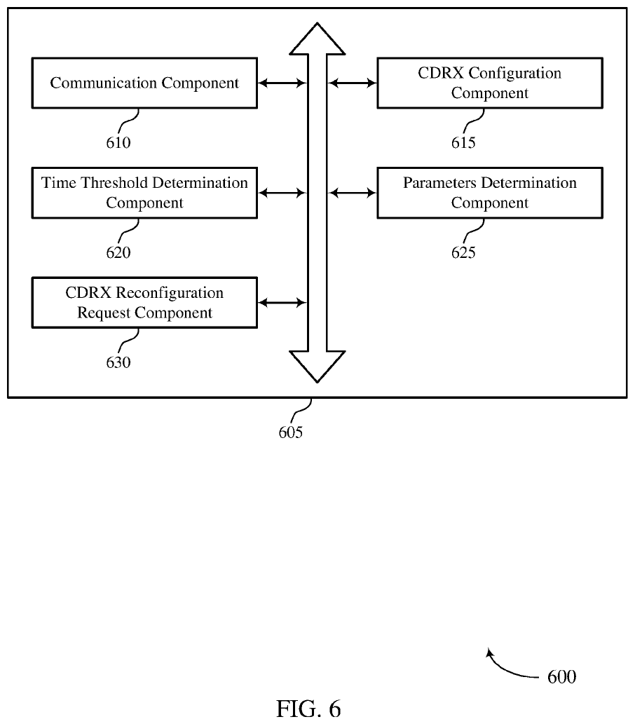

FIG. 6 shows a block diagram 600 of a communications manager 605 that supports techniques for configuring connected mode discontinuous reception (CDRX) in DC in accordance with aspects of the present disclosure. The communications manager 605 may be an example of aspects of a communications manager 515, or a communications manager 710 described herein. The communications manager 605 may include a communication component 610, an CDRX configuration component 715, a reconfiguration component 720, a first dedicated radio configuration component 725, a second dedicated radio configuration component 730, and an RRC connection reconfiguration complete component 735. Each of these components may communicate, directly or indirectly, with one another (e.g., via one or more buses).

The communication component 610 may communicate with an MN and an SN in a DC mode. In some cases, the DC mode includes an EUTRA-EUTRA DC mode, an NR-NR DC mode, an NR-EUTRA DC mode, an EUTRA-NR DC mode, an NGC EUTRA-NR DC mode, or a combination thereof. Alternatively, or in addition to, the communication component 610 may communicate with a local wireless area network (WLAN). For example, the component 610 may communicate with an MN, an SN and/or a Wi-Fi access point.

The CDRX configuration component 615 may receive, from the MN (first cell) associated with a first radio access technology (RAT), a first connected mode discontinuous reception (CDRX) configuration, the first CDRX configuration may include a first indication of a first ON occasion. The CDRX configuration component 615 may receive, from the SN (second cell) associated with a second radio access technology (RAT), a second CDRX configuration, the second CDRX configuration may include a second indication of a second ON occasion.

The time threshold determination component 620 may determine whether the first ON occasion of the first connected mode discontinuous reception (CDRX) configuration is separated from the second ON occasion of the second connected mode discontinuous reception (CDRX) configuration by more than a time threshold. When the time threshold determination component 620 determines that the first ON occasion of the first connected mode discontinuous reception (CDRX) configuration is separated from the second ON occasion of the second connected mode discontinuous reception (CDRX) configuration by more than a time threshold, the parameters determination component 625 may determine one or more CDRX reconfiguration parameters.

The CDRX reconfiguration request component 630 may transmit a CDRX reconfiguration request message to the MN and/or the SN.

FIG. 7 shows a diagram of a system 700 including a device 705 that supports techniques for configuring connected mode discontinuous reception (CDRX) in DC in accordance with aspects of the present disclosure. The device 705 may be an example of or include the components of device 505, device 605, or a UE 115 as described herein. The device 705 may include components for bi-directional voice and data communications including components for transmitting and receiving communications, including a communications manager 710, an I/O controller 715, a transceiver 720, an antenna 725, memory 730, and a processor 740. These components may be in electronic communication via one or more buses (e.g., bus 745).

The communications manager 710 may communicate with an MN and an SN in a DC mode, receive, from the MN, associated with a first radio access technology (RAT), a first connected mode discontinuous reception (CDRX) configuration, the first CDRX configuration includes a first indication of a first ON occasion. The communications manager 710 may, receive, from the SN associated with a second radio access technology (RAT), a second CDRX configuration, the second CDRX configuration include a second indication of a second ON occasion. The communication manager 710 may determine that the first on occasion and the second on occasion are separated by a threshold, determine, based at least in part on the determination that the first on occasion and the second on occasion are separated by the threshold, one or more CDRX reconfiguration parameters, and transmit, based at least in part on the determination that the first on occasion and the second on occasion are separated by the threshold, a CDRX reconfiguration request message.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described above. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the wireless device may include a single antenna 725. However, in some cases the device may have more than one antenna 725, which may be capable of concurrently transmitting or receiving multiple wireless transmissions.

The memory 730 may include random-access memory (RAM) and read-only memory (ROM). The memory 730 may store computer-readable, computer-executable code 735 including instructions that, when executed, cause the processor to perform various functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for indicating full configuration to an SN in DC).

The code 735 may include instructions to implement aspects of the present disclosure, including instructions to support wireless communications. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

FIG. 8 shows a block diagram 800 of a device 805 that supports techniques for configuring connected mode discontinuous reception (CDRX) in DC in accordance with aspects of the present disclosure. The device 805 may be an example of aspects of a base station 105 as described herein. The device 805 may include a receiver 810, a communications manager 815, and a transmitter 820. The device 805 may also include a processor. Each of these components may be in communication with one another (e.g., via one or more buses).

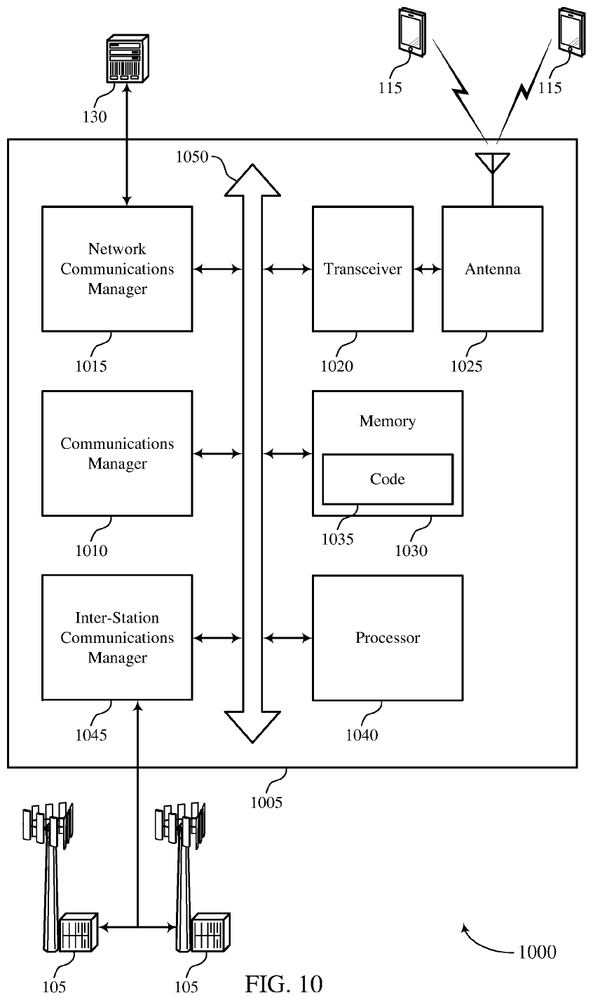

The receiver 810 may receive information such as packets, user data, or control information associated with various information channels (e.g., control channels, data channels, and information related to techniques for configuring connected mode discontinuous reception (CDRX) in DC, etc.). Information may be passed on to other components of the device 805. The receiver 810 may be an example of aspects of the transceiver 1020 described with reference to FIG. 10. The receiver 810 may utilize a single antenna or a set of antennas.

The communications manager 815, if operating according to MN functionality, may determine a first connected mode discontinuous reception (CDRX) configuration, the first CDRX configuration may include a first indication of a first ON occasion. The communications manager 815 may transmit the first connected mode discontinuous reception (CDRX) configuration to the UE 115. The communications manager 815 may receive a CDRX reconfiguration request message from the UE 115. The CDRX reconfiguration request message may include one or more CDRX reconfiguration parameters. The communications manager 815 may determine a first reconfigured connected mode discontinuous reception (CDRX) configuration based at least in part on the one or more CDRX reconfiguration parameters. For example, the first reconfigured connected mode discontinuous reception (CDRX) configuration may include a first indication of a first reconfigured ON occasion. The communications manager 815 may transmit the first reconfigured connected mode discontinuous reception (CDRX) configuration having a first indication of a first reconfigured ON occasion.

The communications manager 815, if operating according to SN functionality, may determine a second connected mode discontinuous reception (CDRX) configuration, the second CDRX configuration may include a second indication of a second ON occasion. The communications manager 815 may transmit the second connected mode discontinuous reception (CDRX) configuration to the UE 115. The communications manager 815 may receive a CDRX reconfiguration request message from the UE 115. The CDRX reconfiguration request message may include one or more CDRX reconfiguration parameters. The communications manager 815 may determine a second reconfigured connected mode discontinuous reception (CDRX) configuration based at least in part on the one or more CDRX reconfiguration parameters. For example, the second reconfigured connected mode discontinuous reception (CDRX) configuration may include a second indication of a second reconfigured ON occasion. The communications manager 815 may transmit the second reconfigured connected mode discontinuous reception (CDRX) configuration having a second indication of a second reconfigured ON occasion.

The communications manager 815, or its sub-components, may be implemented in hardware, code (e.g., software or firmware) executed by a processor, or any combination thereof. If implemented in code executed by a processor, the functions of the communications manager 815, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The communications manager 815, or its sub-components, may be physically located at various positions, including being distributed such that portions of functions are implemented at different physical locations by one or more physical components. In some examples, the communications manager 815, or its sub-components, may be a separate and distinct component in accordance with various aspects of the present disclosure. In some examples, the communications manager 815, or its sub-components, may be combined with one or more other hardware components, including but not limited to an I/O component, a transceiver, a network server, another computing device, one or more other components described in the present disclosure, or a combination thereof in accordance with various aspects of the present disclosure.

The transmitter 820 may transmit signals generated by other components of the device 805. In some examples, the transmitter 820 may be collocated with a receiver 810 in a transceiver component. For example, the transmitter 820 may be an example of aspects of the transceiver 1020 described with reference to FIG. 10. The transmitter 910 may utilize a single antenna or a set of antennas.

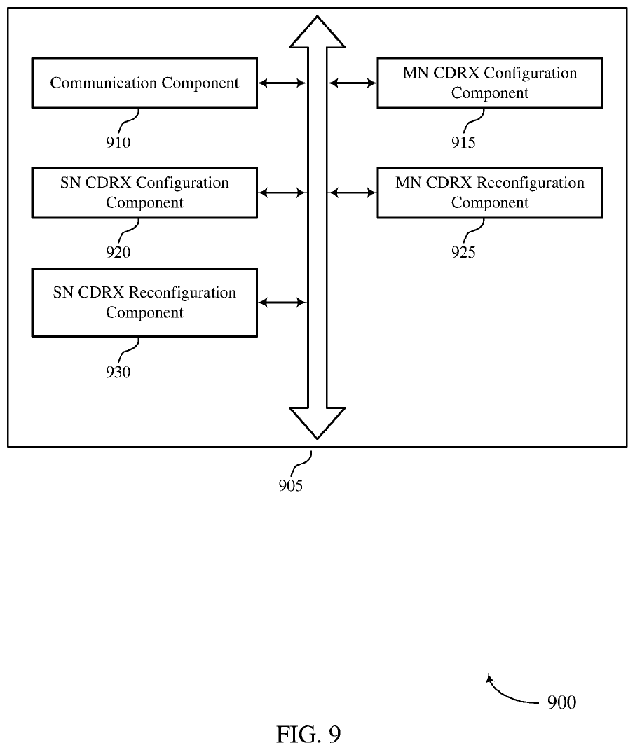

FIG. 9 shows a block diagram 900 of a communications manager 905 that supports techniques for configuring connected mode discontinuous reception (CDRX) in DC in accordance with aspects of the present disclosure. The communications manager 905 may be an example of aspects of a communications manager 815, or a communications manager 1010 described herein. The communications manager 905 may include a communication component 910, an MN CDRX configuration component 915, an SN CDRX configuration component 920, an MN CDRX reconfiguration component 925, and an SN CDRX configuration component 930. Each of these components may communicate, directly or indirectly, with one another (e.g., via one or more buses).

The communication component 910 may communicate with a UE operating in a DC mode. In some examples, the communication component 910 may establish a first radio resource control (RRC) connection with the UE operating in the DC mode. In other aspects, the communication component 910 may establish a second radio resource control (RRC) connection with the UE operating in the DC mode. In some cases, the DC mode includes an EUTRA-EUTRA DC mode, an NR-NR DC mode, an NR-EUTRA DC mode, an EUTRA-NR DC mode, an NGC EUTRA-NR DC mode, or a combination thereof.

The MN CDRX configuration component 915 may determine a first connected mode discontinuous reception (CDRX) configuration for a first cell associated with a first radio access technology (RAT), the first CDRX configuration may include a first indication of a first ON occasion. The SN CDRX configuration component 920 may determine a second CDRX configuration for a second cell associated with a second RAT, the second CDRX configuration may include a second indication of a second ON occasion.

The MN CDRX reconfiguration component 925 may receive, from the UE, a CDRX reconfiguration request message. The MN CDRX reconfiguration component 925 may identify one or more CDRX reconfiguration parameters included in the CDRX reconfiguration request message. The MN CDRX reconfiguration component 925 may determine a first reconfigured connected mode discontinuous reception (CDRX) configuration based at least in part on the one or more CDRX reconfiguration parameters. For example, the MN CDRX reconfiguration component 925 may determine a first reconfigured ON occasion for the first reconfigured connected mode discontinuous reception (CDRX) configuration.

The SN CDRX reconfiguration component 930 may receive, from the UE, a CDRX reconfiguration request message. The SN CDRX reconfiguration component 930 may identify one or more CDRX reconfiguration parameters included in the CDRX reconfiguration request message. The SN CDRX reconfiguration component 930 may determine a second reconfigured connected mode discontinuous reception (CDRX) configuration based at least in part on the one or more CDRX reconfiguration parameters. For example, the SN CDRX reconfiguration component 930 may determine a second reconfigured ON occasion for the second reconfigured connected mode discontinuous reception (CDRX) configuration.

The communication component 910 may communicate to the UE the first reconfigured connected mode discontinuous reception (CDRX) configuration having a first indication of a first reconfigured ON occasion and/or a second connected mode discontinuous reception (CDRX) configuration having a second indication of a second reconfigured ON occasion.

FIG. 10 shows a diagram of a system 1000 including a device 1005 that supports techniques for configuring connected mode discontinuous reception (CDRX) in DC in accordance with aspects of the present disclosure. The device 1005 may be an example of or include the components of device 805, device 905, or a base station 105 as described herein. The device 1005 may include components for bi-directional voice and data communications including components for transmitting and receiving communications, including a communications manager 1010, a network communications manager 1015, a transceiver 1020, an antenna 1025, memory 1030, a processor 1040, and an inter-station communications manager 1045. These components may be in electronic communication via one or more buses (e.g., bus 1050).

In some cases, the communications manager 1010, if operating according to MN functionality, may determine a first connected mode discontinuous reception (CDRX) configuration, the first CDRX configuration may include a first indication of a first ON occasion. The communications manager 815 may transmit the first connected mode discontinuous reception (CDRX) configuration to the UE 115. The communications manager 815 may receive a CDRX reconfiguration request message from the UE 115. The CDRX reconfiguration request message may include one or more CDRX reconfiguration parameters. The communications manager 815 may determine a first reconfigured connected mode discontinuous reception (CDRX) configuration based at least in part on the one or more CDRX reconfiguration parameters. For example, the first reconfigured connected mode discontinuous reception (CDRX) configuration may include a first indication of a first reconfigured ON occasion. The communications manager 815 may transmit the first reconfigured connected mode discontinuous reception (CDRX) configuration having a first indication of a first reconfigured ON occasion.

In some cases, the communications manager 1010, if operating according to SN functionality, may determine a second connected mode discontinuous reception (CDRX) configuration, the second CDRX configuration may include a second indication of a second ON occasion. The communications manager 815 may transmit the second connected mode discontinuous reception (CDRX) configuration to the UE 115. The communications manager 815 may receive a CDRX reconfiguration request message from the UE 115. The CDRX reconfiguration request message may include one or more CDRX reconfiguration parameters. The communications manager 815 may determine a second reconfigured connected mode discontinuous reception (CDRX) configuration based at least in part on the one or more CDRX reconfiguration parameters. For example, the second reconfigured connected mode discontinuous reception (CDRX) configuration may include a second indication of a second reconfigured ON occasion. The communications manager 815 may transmit the second reconfigured connected mode discontinuous reception (CDRX) configuration having a second indication of a second reconfigured ON occasion.

The network communications manager 1015 may manage communications with the core network 130 (e.g., via one or more wired backhaul links). For example, the network communications manager 1015 may manage the transfer of data communications for client devices, such as one or more UEs 115.

The transceiver 1020 may communicate bi-directionally, via one or more antennas, wired, or wireless links as described above. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions.

The memory 1030 may include RAM, ROM, or a combination thereof. The memory 1030 may store computer-readable code 1035 including instructions that, when executed by a processor (e.g., the processor 1040) cause the device to perform various functions described herein. In some cases, the memory 1030 may contain, among other things, a BIOS which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some cases, a memory controller may be integrated into processor 1040. The processor 1040 may be configured to execute computer-readable instructions stored in a memory (e.g., the memory 1030) to cause the device 1005 to perform various functions (e.g., functions or tasks supporting techniques for configuring connected mode discontinuous reception (CDRX) in DC).

The inter-station communications manager 1045 may manage communications with other base station 105 and may include a controller or scheduler for controlling communications with UEs 115 in cooperation with other base stations 105. For example, the inter-station communications manager 1045 may coordinate scheduling for transmissions to UEs 115 for various interference mitigation techniques such as beamforming or joint transmission. In some examples, the inter-station communications manager 1045 may provide an X2 interface within an LTE/LTE-A wireless communication network technology to provide communication between base stations 105.

The code 1035 may include instructions to implement aspects of the present disclosure, including instructions to support wireless communications. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

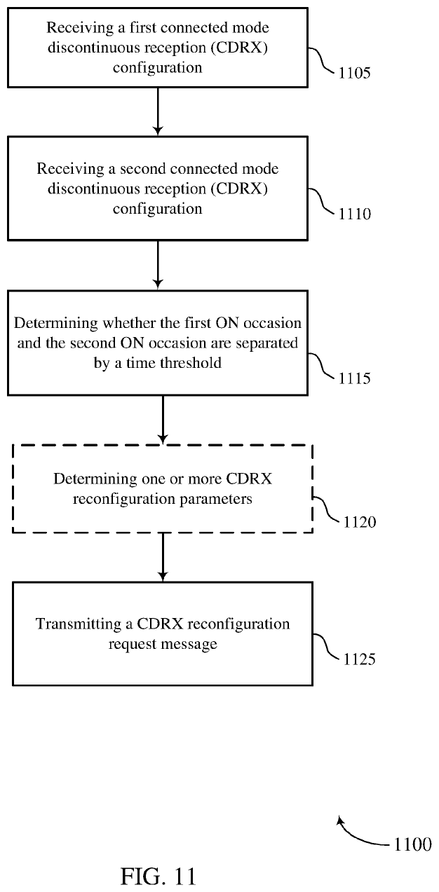

FIG. 11 shows a flowchart illustrating a method 1100 that supports techniques for configuring connected mode discontinuous reception (CDRX) configuration in DC in accordance with aspects of the present disclosure. The operations of method 1300 may be implemented by a UE 115 or its components as described herein. For example, the operations of method 1100 may be performed by a communications manager as described with reference to FIGS. 5 through 7. In some examples, a UE may execute a set of instructions to control the functional elements of the base station to perform the functions described below. Additionally or alternatively, a UE may perform aspects of the functions described below using special-purpose hardware.

At 1105, the UE, operating in a DC mode, may receive a first connected mode discontinuous reception (CDRX) configuration from a first cell (e.g., MN) associated with a first radio access technology. The first connected mode discontinuous reception (CDRX) configuration may include a first indication of a first ON occasion. The operations of 1105 may be performed according to the methods described herein. In some examples, aspects of the operations of 1105 may be performed by a communication component and/or a CDRX configuration component as described with reference to FIGS. 5 through 7.

At 1110, the UE, operating in a DC mode, may receive a second connected mode discontinuous reception (CDRX) configuration from a second cell (e.g., SN) associated with a second radio access technology. The second connected mode discontinuous reception (CDRX) configuration may include a second indication of a second ON occasion. The operations of 1110 may be performed according to the methods described herein. In some examples, aspects of the operations of 1110 may be performed by a communication component and/or a CDRX configuration component as described with reference to FIGS. 5 through 7.

At 1115, the UE may determine whether the first ON occasion indicated by the first connected mode discontinuous reception (CDRX) cycle and the second ON occasion indicated by the second connected mode discontinuous reception (CDRX) cycle are separated by a time threshold. The operations of 1115 may be performed according to the methods described herein. In some examples, aspects of the operations of 1115 may be performed by a time threshold determination component as described with reference to FIGS. 5 through 7.

At 1120, the UE may determine one or more CDRX reconfiguration parameters based at least in part on the determination that the first ON occasion indicated by the first connected mode discontinuous reception (CDRX) cycle and the second ON occasion indicated by the second connected mode discontinuous reception (CDRX) cycle are separated by a time threshold. The operations of 1120 may be performed according to the methods described herein. In some examples, aspects of the operations of 1120 may be performed by a parameter determination component as described with reference to FIGS. 5 through 7.

At 1125, the UE may transmit a CDRX reconfiguration request message based at least in part on the determination that the first ON occasion indicated by the first connected mode discontinuous reception (CDRX) cycle and the second ON occasion indicated by the second connected mode discontinuous reception (CDRX) cycle are separated by a time threshold. The operations of 1125 may be performed according to the methods described herein. In some examples, aspects of the operations of 1125 may be performed by a CDRX reconfiguration request component and/or a communication component as described with reference to FIGS. 5 through 7.

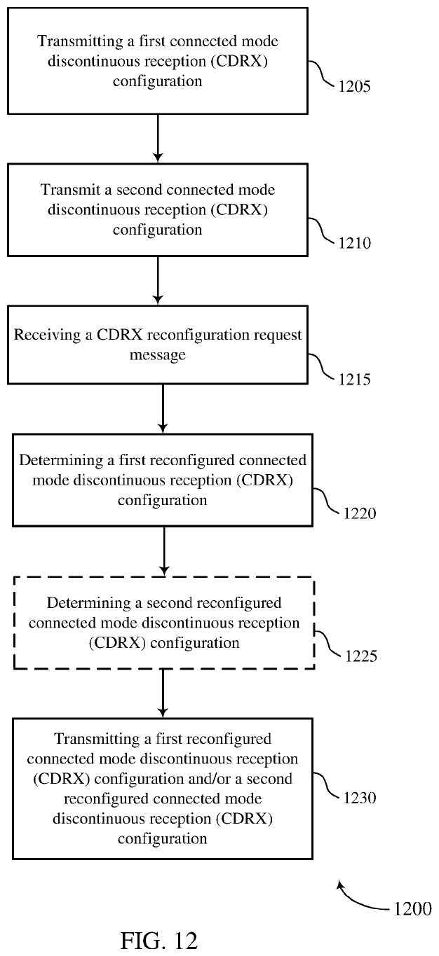

FIG. 12 shows a flowchart illustrating a method 1200 that supports techniques for configuring connected mode discontinuous reception (CDRX) configuration in DC in accordance with aspects of the present disclosure. The operations of method 1200 may be implemented by a base station 105 or its components as described herein. For example, the operations of method 1200 may be performed by a communications manager as described with reference to FIGS. 8 through 10. In some examples, a base station may execute a set of instructions to control the functional elements of the base station to perform the functions described below. Additionally or alternatively, a base station may perform aspects of the functions described below using special-purpose hardware.

At 1205, the base station (e.g., operating as an MN) may transmit a first connected mode discontinuous reception (CDRX) configuration having a first indication of a first ON occasion. The operations of 1205 may be performed according to the methods described herein. In some examples, aspects of the operations of 1205 may be performed by an MN CDRX configuration component as described with reference to FIGS. 8 through 10.

At 1210, the base station (e.g., operating as an SN) may transmit, a second connected mode discontinuous reception (CDRX) configuration having a second indication of a second ON occasion. The operations of 1210 may be performed according to the methods described herein. In some examples, aspects of the operations of 1210 may be performed by an SN CDRX configuration component as described with reference to FIGS. 8 through 10.

At 1215, the base station (e.g., operating as an MN or an SN) may receive a CDRX reconfiguration request message. The operations of 1215 may be performed according to the methods described herein. In some examples, aspects of the operations of 1215 may be performed by an MN CDRX reconfiguration component and/or an SN CDRX reconfiguration component as described with reference to FIGS. 8 through 10.

At 1220, the base station (e.g., operating as an MN) may determine a first reconfigured connected mode discontinuous reception (CDRX) configuration having a first indication of a first reconfigured ON occasion. The operations of 1220 may be performed according to the methods described herein. In some examples, aspects of the operations of 1220 may be performed by an MN CDRX reconfiguration component as described with reference to FIGS. 8 through 10.

At 1225, the base station (e.g., operating as an SN) may (optionally) determine a second reconfigured connected mode discontinuous reception (CDRX) configuration having a second indication of a second reconfigured ON occasion. The operations of 1225 may be performed according to the methods described herein. In some examples, aspects of the operations of 1225 may be performed by an SN CDRX reconfiguration component as described with reference to FIGS. 8 through 10.

At 1230, the base station (e.g., operating as an MN and/or an SN) may transmit a first reconfigured connected mode discontinuous reception (CDRX) configuration having a first indication of a first reconfigured ON occasion and/or a second reconfigured connected mode discontinuous reception (CDRX) configuration having a second indication of a second reconfigured ON occasion. The operations of 1230 may be performed according to the methods described herein. In some examples, aspects of the operations of 1230 may be performed by an MN CDRX reconfiguration component, an SN CDRX reconfiguration component and/or a communication component as described with reference to FIGS. 8 through 10.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communication at a user equipment (UE), comprising:
receiving, by the UE, a first connected mode discontinuous reception (CDRX) configuration from a first cell associated with a first radio access technology (RAT), the first CDRX configuration including a first indication of a first on occasion;
receiving, by the UE, a second CDRX configuration from a second cell associated with a second RAT, the second CDRX configuration including a second indication of a second on occasion;
determining that the first on occasion and the second on occasion are separated by a threshold; and
transmitting, by the UE and based at least in part on the determination that the first on occasion and the second on occasion are separated by the threshold, a CDRX reconfiguration request message.

2. The method of claim 1, further comprising:
establishing a first radio resource connection (RRC) connection with the first cell; and
establishing a second RRC connection with the second cell.

3. (canceled)

4. The method of claim 1, further comprising:
determining, based at least in part on the determination that the first on occasion and the second on occasion are separated by the threshold, one or more CDRX reconfiguration parameters.

5-6. (canceled)

7. The method of claim 1, wherein the CDRX reconfiguration request message is an in-device coexistence indication message.

8. The method of claim 1, further comprising:
repeating the determination and the transmission for a number of attempts.

9-11. (canceled)

12. The method of claim 1, further comprising:
establishing a third radio resource control (RRC) connection with a third cell associated with a third RAT.

13. An apparatus for wireless communication, comprising:
a memory; and
a processor, coupled to the memory, configured to:
receive a first connected mode discontinuous reception (CDRX) configuration from a first cell associated with a first radio access technology (RAT), the first CDRX configuration including a first indication of a first on occasion;
receive a second CDRX configuration from a second cell associated with a second RAT, the second CDRX configuration including a second indication of a second on occasion;
determine that the first on occasion and the second on occasion are separated by a threshold; and
transmit, based at least in part on the determination that the first on occasion and the second on occasion are separated by the threshold, a CDRX reconfiguration request message.

14. The apparatus of claim 13, wherein the processor is further configured to:
establish a first radio resource connection (RRC) connection with the first cell; and
establish a second RRC connection with the second cell.

15. The apparatus of claim 13, wherein the first cell includes a master cell group and the second cell includes a secondary cell group.

16. The apparatus of claim 13, wherein the processor is further configured to:
determine, based at least in part on the determination that the first on occasion and the second on occasion are separated by the threshold, one or more CDRX reconfiguration parameters.

17. The apparatus of claim 16, wherein the one or more CDRX reconfiguration parameters include at least one of a discontinuous reception (DRX) cycle length, a DRX offset or a DRX active time.

18. The apparatus of claim 16, wherein the CDRX reconfiguration request message includes the one or more CDRX reconfiguration parameters.

19. The apparatus of claim 13, wherein the CDRX reconfiguration request message is an in-device coexistence indication message.

20. The apparatus of claim 13, wherein the processor is further configured to:
repeat the determination and the transmission for a number of attempts.

21. The apparatus of claim 20, wherein the processor is further configured to:
stop repeating the determination and the transmission after the number of attempts.

22. The apparatus of claim 13, wherein the first RAT includes one of a new radio (NR), a long-term evolution (LTE), an evolved LTE (eLTE), or a Wi-Fi.

23. The apparatus of claim 13, wherein the second RAT includes one of a new radio (NR), a long-term evolution (LTE), an evolved LTE (eLTE), or a Wi-Fi.

24. The apparatus of claim 13, wherein the processor is further configured to:
establish a third radio resource control (RRC) connection with a third cell associated with a third RAT.

25. An apparatus for wireless communication, comprising:
means for receiving a first connected mode discontinuous reception (CDRX) configuration from a first cell associated with a first radio access technology (RAT), the first CDRX configuration including a first indication of a first on occasion;
means for receiving a second CDRX configuration from a second cell associated with a second RAT, the second CDRX configuration including a second indication of a second on occasion;
means for determining that the first on occasion and the second on occasion are separated by a threshold; and
means for transmitting, based at least in part on the determination that the first on occasion and the second on occasion are separated by the threshold, a CDRX reconfiguration request message.

26. The apparatus of claim 25, further comprising:
means for establishing a first radio resource connection (RRC) connection with the first cell; and
means for establishing a second RRC connection with the second cell.

27. The apparatus of claim 25, wherein the first cell includes a master cell group and the second cell includes a secondary cell group.

28. The apparatus of claim 25, further comprising:
means for determining, based at least in part on the determination that the first on occasion and the second on occasion are separated by the threshold, one or more CDRX reconfiguration parameters.

29-30. (canceled)

31. The apparatus of claim 25, wherein the CDRX reconfiguration request message is an in-device coexistence indication message.

32. The apparatus of claim 25, further comprising:
means for repeating the determination and the transmission for a number of attempts.

33-35. (canceled)

36. The apparatus of claim 25, further comprising:
means for establishing a third radio resource control (RRC) connection with a third cell associated with a third RAT.

37. A non-transitory computer-readable medium storing one or more instructions for wireless communication, the one or more instructions, comprising:
one or more instructions that, when executed by one or more processors of a user equipment (UE), cause the one or more processors to:
receive a first connected mode discontinuous reception (CDRX) configuration from a first cell associated with a first radio access technology (RAT), the first CDRX configuration including a first indication of a first on occasion;
receive a second CDRX configuration from a second cell associated with a second RAT, the second CDRX configuration including a second indication of a second on occasion;
determine that the first on occasion and the second on occasion are separated by a threshold; and
transmit, based at least in part on the determination that the first on occasion and the second on occasion are separated by the threshold, a CDRX reconfiguration request message.

38. The non-transitory computer-readable medium of claim 37, wherein the one or more instructions, when executed by the one or more processors, further cause the one or more processors to:
establish a first radio resource connection (RRC) connection with the first cell; and
establish a second RRC connection with the second cell.

39. The non-transitory computer-readable medium of claim 37, wherein the first cell includes a master cell group and the second cell includes a secondary cell group.

40. The non-transitory computer-readable medium of claim 37, wherein the one or more instructions, when executed by the one or more processors, further cause the one or more processors to:
determine, based at least in part on the determination that the first on occasion and the second on occasion are separated by the threshold, one or more CDRX reconfiguration parameters.

41-43. (canceled)

44. The non-transitory computer-readable medium of claim 37, wherein the one or more instructions, when executed by the one or more processors, further cause the one or more processors to:
repeat the determination and the transmission for a number of attempts.

45-48. (canceled)
